(19) United States
(12) Patent Application Publication
(10) Pub. No.: US 2014/0178832 A1
(43) Pub. Date: Jun. 26, 2014

(54) SYSTEM AND METHOD FOR PROVIDING COMPACT NAVIGATION-BASED SURGICAL GUIDE IN DENTAL IMPLANT SURGERY

(71) Applicants: Woncheol Choi, San Jose, CA (US); Jia Leung Mar, Union City, CA (US)

(72) Inventors: Woncheol Choi, San Jose, CA (US); Jia Leung Mar, Union City, CA (US)

(73) Assignee: Anatomage Inc., San Jose, CA (US)

(21) Appl. No.: 13/725,605

(22) Filed: Dec. 21, 2012

(51) Int. Cl. A61C 8/00

(52) U.S. Cl. CPC A61C 8/0089
USPC 433/27; 433/174

(57) ABSTRACT

A system and method for providing compact navigation-based surgical guide for dental implant surgery is disclosed. According to one embodiment, a surgical guide system comprise includes a surgical guide comprising having a tracking marker. The surgical guide is fabricated to be custom fitted to a patient's mouth or jawbone. The tracking marker is placed at an implant site according to a virtual implant plan. A sensor placed on a drill piece detects electromagnetic signals that are used to determine the position of the tracking marker. A computer in communication with the sensor processes the tracking marker data received from the sensor, determines a relative position of the drill piece with respect to the tracking marker, and provides real-time tracking of the drill piece on the display of the computer.

### FIELD

The field of the invention relates generally to dental implant surgery, and more particularly to system and method for providing compact navigation-based surgical guide in dental implant surgery.

### BACKGROUND

With increasing use of CT scans in dentistry, dental implant surgery is becoming computer-guided surgery. In a typical computer-guided surgery, a doctor reviews a patient's CT scan and plans a surgical procedure in specialized software. After the surgical plan is complete, the doctor sends the plan data to a surgical guide company, and the surgical guide company sends back a surgical guide that follows the doctor's plan. The surgical guide is fabricated to custom fit to the patient and has a sleeve guiding a drill. By drilling with the surgical guide, the doctor can accomplish the surgery with great accuracy as planned on the software. This computer-guided surgery has a significant improvement over traditional dental surgery with no guiding tools.

However, the surgical guided surgery has some limitations. One of the limitations is mainly due to the drilling through a sleeve. Typically, the doctor uses a sequence of multiple drills with different diameters for a single site. Thus, for each drill in the sequence, a matching sleeve has to be used. The placement of matching sleeves can be done by either changing the guide or using an adapter that fits the sleeve. This makes the guide more complicated and need to hold the adapter as well as the drill piece. Another limitation is that the shape of the drill is not necessary straight. Frequently tapered drills are to be used for tapered shaped implants. In this case, the sleeve cannot directly guide the tapered drill. Yet another limitation is that the sleeve adds additional height on top of patient soft tissue, in which case the drill has to pass through the sleeve. With the limited space in mouth especially in the posterior region, it is difficult to insert the drill through the sleeve.

A surgical navigation system uses a tracking marker that is attached to the drill piece and another tracking marker that seats onto the patient's mouth or jawbone. The tracking markers emit a signal that an external sensor acquires. The system may also have an external device that emits a signal to the tracking markers, and subsequently the tracking markers relay a modified signal to the external sensor. The external sensor sends data to a computer running navigation software. The navigation software processes the data, for example, using a triangulation algorithm, to calculate the 3D coordinates of the tracking markers on the drill piece and patient's mouth. The navigation software then shows real-time positioning of the tool with respect to the patient's mouth or jawbone. The difficulty with this navigation system is that the tracking marker is bulky. Any obstructions between the marker, signal emitter, or sensor can hinder the accuracy. Also, the external sensor and signal emitter are typically large and takes up significant space within the vicinity of the doctor and patient. Resultantly, doctors have a limited space to operate surgery due to the bulkiness of the tracking device within the patient's mouth and equipment nearby.

Recent advancements allow for the sensors to be smaller in size and to have better data acquisition. The external sensor of a navigation system was made smaller and fitted on to the dental drill piece. The tracking markers can also be made smaller, while the signal acquired by the sensor is sufficient in accuracy.

### SUMMARY

A system and method for providing compact navigation-based surgical guide in dental implant surgery is disclosed. According to one embodiment, a surgical guide system comprises a surgical guide comprising a tracking marker. The surgical guide is fabricated to be custom fitted to a patient's mouth or jawbone. The tracking marker is placed at an implant site according to a virtual implant plan. A sensor placed on a drill piece detects electromagnetic signals that are used to determine the position of the tracking marker. A computer in communication with the sensor processes the tracking marker data received from the sensor, determines a relative position of the drill piece with respect to the tracking marker, and provides real-time tracking of the drill piece on the display of the computer.

It is an objective of the present invention to provide a compact navigation-based surgical guide system that overcomes the limitations of a sleeve-based surgical guide and problems of a typical surgical navigation system.

It is another objective of the present invention to provide a 3D tracking system that tracks the position and orientation of a drill piece with respect to the patient's anatomy.

It is yet another objective of the present invention to provide a precise controlled drilling capability at an implant site in dental implant surgery.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates an exemplary 3D image of a patient's mouth or jawbone rendered in implant planning software, according to one embodiment;

FIG. 2 illustrates an exemplary computer aided designed virtual model of an implant surgical guide, according to one embodiment;

FIG. 3 illustrates an exemplary physical surgical guide fabricated from a virtual surgical guide model, according to one embodiment;

FIG. 4 illustrates an exemplary drill piece, according to one embodiment;

FIG. 5 illustrates an exemplary tracking process of detecting a tracking marker, according to one embodiment; and

FIG. 6 illustrates an exemplary view of a drill piece tracked relative to an implant plan, according to one embodiment.

It should be noted that the figures are not necessarily drawn to scale and that elements of structures or functions are generally represented by reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A system and method for providing compact navigation-based surgical guide in dental implant surgery is disclosed. According to one embodiment, a surgical guide system comprises a surgical guide comprising a tracking marker. The surgical guide is fabricated to be custom fitted to a patient's mouth or jawbone. The tracking marker is placed at an implant site according to a virtual implant plan. A sensor placed on a drill piece detects electromagnetic signals that are used to determine the position of the tracking marker. A computer in communication with the sensor processes the tracking marker data received from the sensor, determines a relative position of the drill piece with respect to the tracking marker, and provides real-time tracking of the drill piece on the display of the computer.

In the following description, for purposes of clarity and conciseness of the description, not all of the numerous components shown in the schematic are described. The numerous components are shown in the drawings to provide a person of ordinary skill in the art a thorough enabling disclosure of the present invention. The operation of many of the components would be understood to one skilled in the art.

Each of the additional features and teachings disclosed herein can be utilized separately or in conjunction with other features and teachings to provide the present table game. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense and are instead taught merely to describe particularly representative examples of the present teachings.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples.

In planning a dental implant, a doctor creates a virtual implant plan based on the CT image data of a patient. Based on the virtual implant plan, a computer-aided designed (CAD) dental implant surgical guide is fabricated to fit onto the patient's mouth. According to one embodiment, a surgical guide custom is fabricated with an access hole and at least one tracking marker at each implant surgery site. The tracking marker's position on the surgical guide is determined based on the planned implant position as a part of the virtual implant plan. According to one embodiment, a drill piece fitted with one or more sensors is provided. The offset dimensions of the drill piece including the drill bit is measured and registered. The fabricated surgical guide is positioned in the patient's mouth in the same position as it was designed from in the virtual implant plan.

The sensor on the drill piece acquires data and sends the data to a computer running navigation software. According to one embodiment, navigation software provides real-time visual feedback of the drill piece with respect to the virtual implant plan. The navigation software processes the data (e.g., triangulation) to calculate the position of the tracking markers relative to the position the drill piece. The navigation software matches the calculated position of the tracking marker to its predetermined position from the virtual implant plan. This determines the relative position of the drill piece with respect to the implant position in the virtual implant plan. The navigation software renders the drill piece in its actual position and orientation in real-time relative to the implant position in the virtual implant plan.

With a real-time tracking capability of a drill piece within an implant plan, the doctor has a precise control of surgical drilling position and trajectory. There is no limitation of sleeves that do not guide certain drills. Since no sleeves are required, there is no additional height added by sleeves and no sleeve adapters are necessary. This provides a doctor more precise control of surgical drilling and allows for an easier and faster surgical process without having to have mechanical limitations of a sleeve-based surgical guide system. Nor is there large equipment typically used for surgical navigation systems, in the vicinity of the doctor and patient.

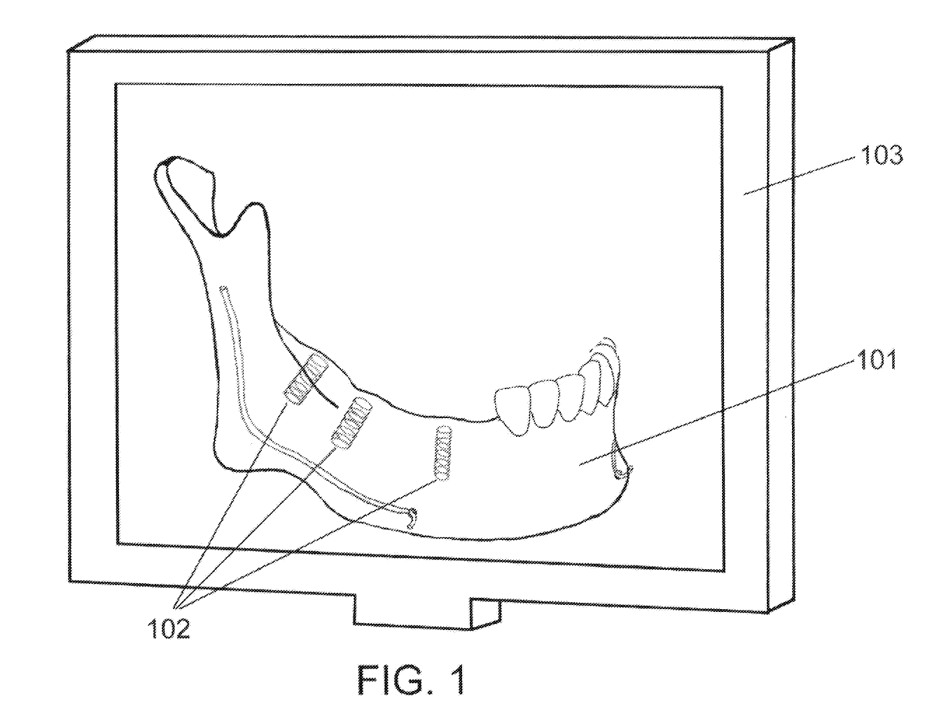

Surgical planning software creates a virtual dental implant plan using 3D medical scan images of the patient, such as a CT scan data. FIG. 1 illustrates an exemplary 3D image of a patient's mouth or jawbone 101 rendered in implant planning software on a computer display 103, according to one embodiment. The surgical planning software allows the doctor to visualize the patient's anatomy in 2D and/or 3D space and create a virtual implant plan, in which the doctor decides to places one or more virtual implant models 102 in desired locations within patient's anatomy.

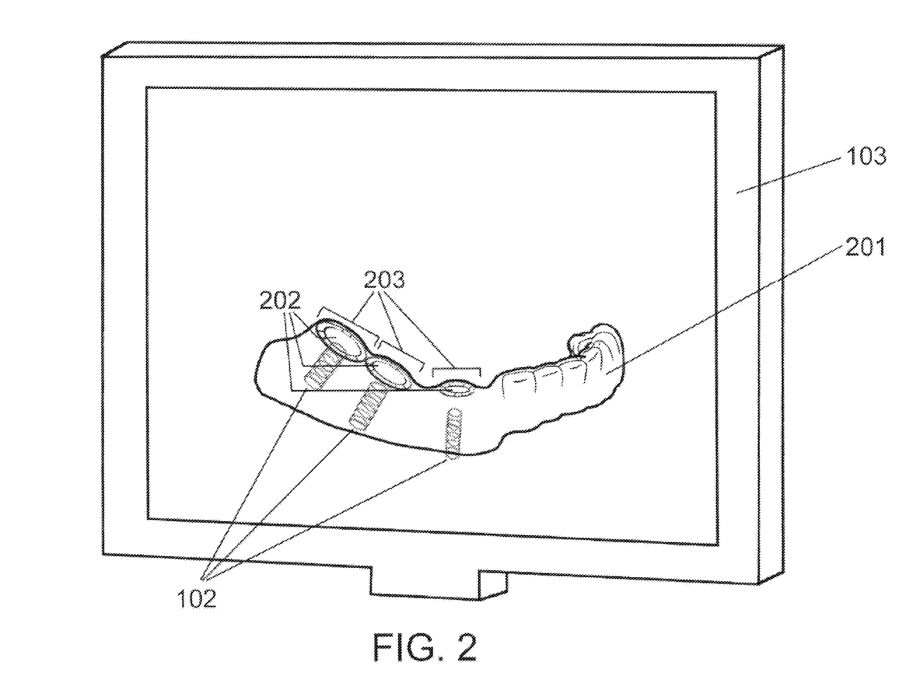

FIG. 2 illustrates an exemplary computer aided designed virtual model of an implant surgical guide, according to one embodiment. A dental implant surgical guide 201 is fabricated based on the doctor's implant plan. The virtual model of the surgical guide 201 is created and designed to custom fit onto the patient's mouth or jawbone to provide guidance when drilling an implant hole at the desired locations during a surgery. The virtual implant trajectories are precisely transferred from the implant plan to the surgical guide model 201. On the virtual surgical guide model 201, one or more access holes 202 are placed at each desired implant site. During surgical operation, the doctor has a drilling access to the patient's anatomy through access holes 202. Each of the access holes 202 is centered about the implant site and is made to be wide enough to allow larger drill bits to pass without interference. One or more virtual tracking markers 203 are placed at each implant site. The position of virtual markers 203 is determined based on the virtual implant site and planned trajectories. Instead of a virtual surgical guide model 201, a virtual mold of the patient's mouth or jawbone may be used. The position of the tracking markers 203 is determined prior to physical fabrication.

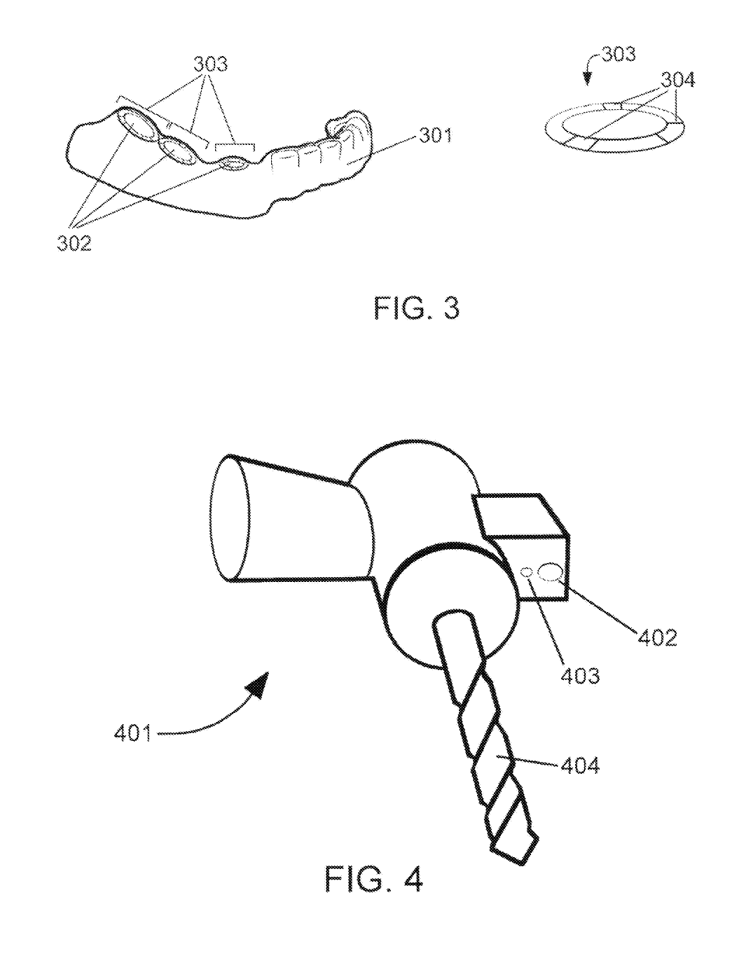

FIG. 3 illustrates an exemplary physical surgical guide fabricated from a virtual surgical guide model, according to one embodiment. The physical surgical guide 301 is fabricated from the virtual surgical guide model 201 and includes access holes 302 and optical tracking markers 303. In one embodiment, the surgical guide 301 is fabricated through direct prototyping of the corresponding virtual guide model 201 or physical forming from a mold. However, a person having ordinary skill in the art would understand that the fabrication of a surgical guide 301 is well known in the art, thus is not limited to a particular process. Instead, fabrication of a surgical guide 301 can be done by different fabrication processes using a wide variety of materials. Access holes 302 on the surgical guide 301 may be formed after the surgical guide 301 is fabricated, for example, by drilling or cutting. In another embodiment, the surgical guide 301 is fabricated from direct prototyping, for example, 3D printing, with key features such as access holes 302. Excessive materials may be removed or cleaned after fabrication.

Physical tracking markers 303 are stably affixed to the surgical guide. The surgical guide may have pre-designed sockets or other physical features that allow precise mating with the tracking marker 303 at the intended position. Alternatively, the markers 303 may be placed at the intended position with assistance of a customized assembly instrument. The markers may be rigidly attached to the surgical guide 301 through tight fitting, mechanical connection, or adhesive. The position and critical features of the physical tracking marker 303 are identical to the corresponding virtual tracking marker 203 at each implant site. Each of the tracking markers 303 may consist of more than one marking objects 304.

The marking object 304 emits an electromagnetic signal within a necessary range of frequency and wavelength. Alternatively, the marking object 304 may receive an electromagnetic signal emitted from an external device, in which case it may reflect the signal or it may alter the signal and emit an altered signal. The marking object 304 may either be passive or inert without requiring a power, or contain one or more active components requiring a power source to actively function. For actively powered marking object 304, a light emitting diode (LED), infrared bulb, RFID tag, or other types of active devices that emit an electromagnetic signal may be used. The material, shape, and other pertinent qualities of the marking object 304 are chosen for the type of electromagnetic signal being emitted or reflected. It is understood that marking objects 304 can be made of various forms of materials, shapes, inert or actively powered device, without deviating the scope of the present subject matter. The overall size of tracking marker 303 and its marking objects 304 is sufficiently small as to be affixed to the surgical guide 301 without imposing as an obstruction. The height of the tracking markers may vary depending on the application, the geometrical limitations, material choice, etc. In a preferred embodiment, tracking markers 304 are thin and short as to not to interfere with surgical tools or sensor during a surgery.

FIG. 4 illustrates an exemplary drill piece, according to one embodiment. The drill piece 401 has a head fitted with drill bit 404 and other components for real-time navigation. One or more detection sensors 402 are affixed to the drill piece 401 and point in the same direction as the drill bit 404. For a passive marking object that does not emit an electromagnetic signal, a signal emitting device 403 emits an electromagnetic signal instead to track markers. One or more signal emitting devices 403 are also affixed to the drill piece 401. When multiple sensors 402 and signal emitters 403 are used, the dimensions and spacing between them must be known by the navigation software for dimensional calculations and navigation based on the results of calculations.

In one embodiment, the sensor 402 and signal emitter 403 may be made to be mountable on the drill piece 401 or permanently affixed to the drill piece. In another embodiment, the sensor 402 and signal emitter 403 are detachable and stably secured onto the drill piece 401. The type of sensor 402 and signal emitter 403 is dependent on the type of electromagnetic signal being used. The sensor 402 is a device ideal for detecting the frequency and wavelength of the electromagnetic signal, whether it is visible light, infra-red, radio waves, or the like. Such sensors include, but are not limited to, a CCD or CMOS camera, RFID receptor. Likewise, the signal emitter 403 is a device ideal for emitting a controlled electromagnetic signal in the necessary range of frequency and wavelength. Such signal emitters include, but are not limited to, a LED, infra-red bulb, RFID reader, and other signal emitting devices. Preferably, the sensor 402 has sufficient resolution and sensitivity to acquire accurate data. The sensor 402 and signal emitter 403 are sufficiently small to be affixed the drill piece head without causing obstruction during surgery. Compared to a conventional drill piece design, the drill piece 401 are comparable or even smaller with integrated sensor 402 and signal emitter 403. Therefore, the overall dimension of the drill piece 401 does not increase compared to a conventional drill piece. This gives spatial advantage over a sleeve-based surgical guide system because the additional height of a sleeve has been lifted with the present navigation system. This also gives a greater spatial advantage over a typical surgical navigation system because the large equipment in the vicinity of the doctor and patient is not necessary as it has been shrunken down and positioned on the drill piece 401. There is no substantial additional spatial constraint has been introduced with the drill piece 401.

The data output of the sensor 402 is sent to a computer that runs navigation software. According to one embodiment, the sensor 402 and the computer are connected wiredly, for example, through a USB (universal serial bus (USB) port or over a standard wireless data communication protocol such as Bluetooth, Wi-Fi, etc.

The offset dimensions of the drill bit 404 to the sensor 402 is precisely measured and registered into the navigation software. Other dimensional data are also provided to the navigation software for rendering accurate images. The data provided to the navigation software accurately determines the position of the drill piece, the drill bit, and other components, and render their images accordingly. Drill bits are available in different sizes, therefore the offset dimensions of available drill bits need to be properly registered into the navigation software.

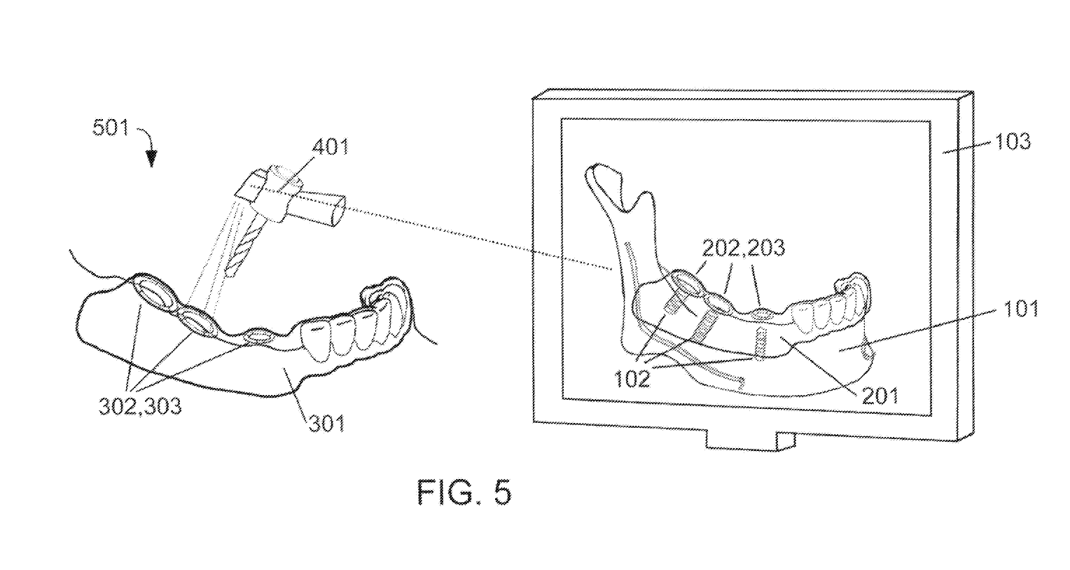

FIG. 5 illustrates an exemplary tracking process of detecting a physical marker, according to one embodiment. With the surgical guide 301 on the patient's mouth 501, the drill piece 401 is moved into position over an implant surgical site. The surgical site identifiable with the tracking marker 303 is within the detection field and range of the sensor 402. If present, the signal emitter 403 is also within range such that its signal is received by the marker objects 304. The sensor 402 acquires real-time data including the signal information of the marker objects 304 of the intended tracking marker 303, and the acquired data is sent to the computer to be processed by the navigation software.

Each data sample is a frame of fixed resolution where each pixel in the frame is a scalar measure of the signal detected in that area. The navigation software analyzes the data samples and may apply filters to isolate the necessary components of the signal. The software then determines the center of each marking object 304 within each data sample by the intensity of the signal The software calculates 3d coordinates of each marking object 304 in relation to the sensor. When sufficient information of components of a triangle is known, such as length or angles of a triangle, the remaining components can be determined due to standard principles in mathematical geometry.

According to one embodiment, the 3D coordinates of the marking objects 304 are calculated by geometric triangulation. With the calculated coordinates of each marking objects 304, the navigation software determines the position of the corresponding physical tracking marker 303. The navigation software compares the coordinates of object markers 304 with the expected shape and position that is predetermined from the virtual plan, and fits the acquired position of the physical tracking marker 303 to the predetermined position of the virtual tracking marker 203 in the doctor's implant plan. Referring to FIG. 5, the physical tracking marker 303 is correlated to the virtual tracking marker 203 according to the implant plan to provide real-time navigation.

Three or more marking objects 304 are necessary to calculate the position of tracking marker 303 with sufficient accuracy. With more marking objects 304, the accuracy can be improved by averaging out a larger sample size. To prevent cross-referencing of marking objects 304 from different tracking markers 303, the marking objects 304 are arranged to be unique for each tracking marker 303. For example, the spacing between the marking objects 304 may be varied to uniquely identify the tracking marker 303. The color or blinking pattern of marking objects 304 may be programmed to be unique for each tracking marker. It is understood that various techniques may be used to uniquely identify tracking markers 303 without deviating from the scope of the present subject matter. The navigation software uses these unique tracking marker configurations to determine the position of each implant site. The navigation software excludes the detected marking object coordinates that do not exhibit the pattern of the expected tracking marker 303.

The position of the drill piece 401 relative to the acquired position of the physical tracking marker 303 is known. After matching the position of the physical tracking marker 303 to the position of the virtual tracking marker 203, the position of the drill piece relative to the position of the virtual tracking marker 203 is also determined. Therefore, the position of the drill piece relative to the implant plan and patient's anatomical features is determined.

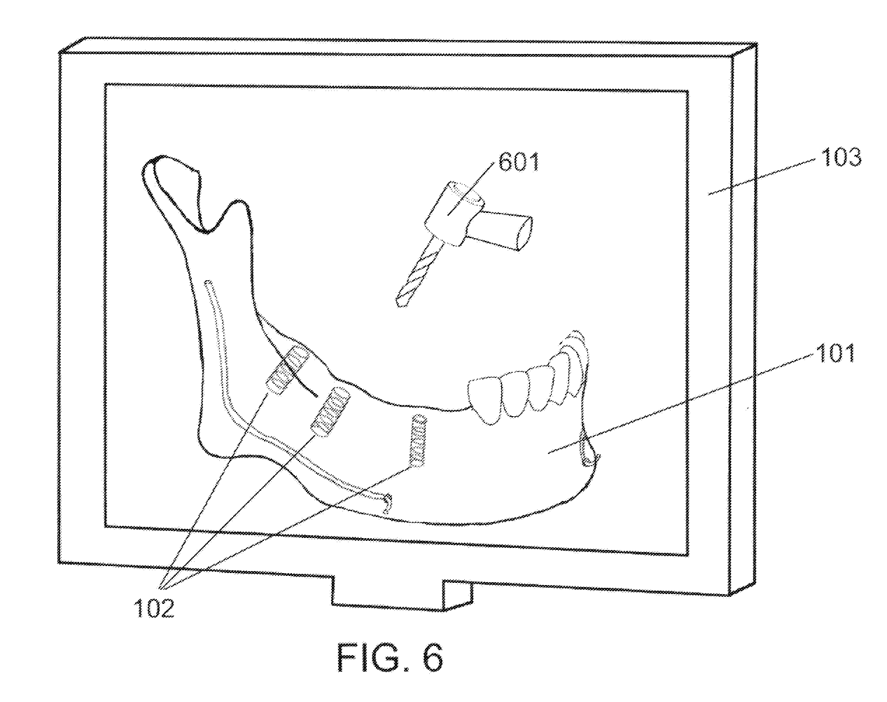

FIG. 6 illustrates an exemplary view of a drill piece tracked relative to an implant plan, according to one embodiment. The navigation software outputs real-time drill piece tracking images to a computer display 103. The computer display 103 is placed in a surgery room to provide real-time visual feedback to the doctor. The position of a virtual drill piece 601 that represents the physical drill piece 401, relative to the virtual implants 102 and the patient's jawbone 101, is updated in real-time through subsequent processing of image frames and calculation of the drill piece position relative to the virtual tracking marker 203. As the doctor moves the physical drill piece, the position of the virtual drill piece 601 is updated to reflect the updated position. When there are none or insufficient marking objects 304 detected, the navigation software is unable to provide real-time navigational information. In this case, the navigation software notifies the doctor on the computer display 103 and/or using the speakers. A time delay may occur as it takes time for data acquisition from the sensor, processing the data samples, position calculation, and rendering to the computer display, however, the time delay can be mitigated with a higher performance computer.

According to one embodiment, navigation software provides an error in position and trajectory of the drill piece relative to the position and trajectory of the implant plan. If configured so, navigation software can calculate and display distance information from critical anatomical structures such as patient mandibular nerve. In cases when navigation software cannot determine or properly update the position of the drill piece, the software notifies the doctor through computer display 103, as to not provide incorrect information to the doctor.

The present real-time navigation method and system provides a doctor with precise information and real-time visual feedback on the positioning and trajectory of a drill piece with respect to the position and trajectory of an implant plan. No sleeve for guiding a drill bit is required; therefore no mechanical limitation is present due to shape and size of a drill bit and/or the additional height required by a sleeve in a limited vertical space inside the patient's mouth. There is also no large equipment within the vicinity of the doctor and patient, which may hinder the doctor's performance.

A method and system for providing compact navigation-based surgical guide in dental implant surgery has been disclosed. Although various embodiments have been described with respect to specific examples and subsystems, it will be apparent to those of ordinary skill in the art that the concepts disclosed herein are not limited to these specific examples or subsystems but extends to other embodiments as well. Included within the scope of these concepts are all of these other embodiments as specified in the claims that follow.

1. A surgical guide system comprising:
a surgical guide comprising a tracking marker, wherein the surgical guide is fabricated to be custom fitted to a patient's mouth or jawbone, and the tracking marker is placed at an implant site according to a virtual implant plan;
a drill piece comprising a sensor and a drill bit, wherein the sensor detects electromagnetic signals from the tracking marker and generates a relative position data of the tracking marker;
a computer comprising a display and connected with the drill piece,
wherein the computer receives the relative position data of the tracking marker from the sensor, determines a relative position of the tracking marker with respect to the drill piece using the relative position data of the tracking marker, correlates the relative position of the tracking marker to a predetermined virtual position of the tracking marker in the virtual implant plan, and provides real-time visual feedback of the drill piece on the display of the computer.

2. The surgical guide system of claim 1, wherein the tracking marker comprises three or more marking objects.

3. The surgical guide system of claim 2, wherein the computer determines the relative position of the tracking marker through geometric triangulation calculation using the three or more marking objects.

4. The surgical guide system of claim 2, wherein the three or more marking objects are placed on a perimeter of the implant site.

5. The surgical guide system of claim 2, wherein the three or more marking objects are passive devices.

6. The surgical guide system of claim 2, wherein the three or more marking objects are active devices emitting the electromagnetic signals, and wherein each of the active devices is selected from a group comprising an LED, an infrared bulb, and a radio frequency ID tag.

7. The surgical guide system of claim 1, wherein the drill piece further comprises an electromagnetic emitter emitting unmodified electromagnetic signals, wherein the three or more marking objects receive the unmodified electromagnetic signals from the electromagnetic emitter and emit the electromagnetic signals.

8. The surgical guide system of claim 1, wherein the surgical guide further comprises an access hole placed at the implant site to allow the drill bit of the drill piece to access the implant site.

9. The surgical guide system of claim 1, wherein the surgical guide further comprises a plurality of tracking markers including the tracking marker that are specific to a plurality of implant sites including the implant site, and each of the plurality of tracking markers has three or more marking objects that are uniquely arranged specific to each of the plurality of tracking markers to identify each of the plurality of tracking markers.

10. The surgical guide system of claim 1, wherein the drill piece communicates with the computer wiredly or wirelessly.

11. The surgical guide system of claim 1, wherein the surgical guide is fabricated according to the virtual implant plan using scanned image data of the patient.

12. The surgical guide system of claim 1, wherein the position of the tracking marker is predetermined according to the virtual implant plan.

13. (canceled)

14. (canceled)

15. (canceled)

16. (canceled)

17. A method for providing real-time tracking of a drill piece during a surgery comprising:
placing a tracking marker on a surgical guide at an implant site according to a virtual plan, wherein the surgical guide is fabricated to be custom fitted to a patient's mouth or jawbone;
receiving a relative position data of the tracking marker from a sensor attached to the drill piece, wherein the sensor detects electromagnetic signals from the tracking marker and generates the relative position data of the tracking marker,
determining a relative position of the tracking marker with respect to the drill piece using the relative position data of the tracking marker;
correlating the relative position of the tracking marker to a predetermined virtual position of the tracking marker in the virtual implant plan; and
providing real-time visual feedback of the drill piece relative to the patient's anatomy on a display.

18. The method of claim 17, wherein the surgical guide is fabricated according to the virtual implant plan using scanned image data of the patient.

19. The method of claim 17, further comprising providing a plurality of tracking markers including the tracking marker that are specific to each of a plurality of implant site including the implant site, wherein each of the plurality of tracking markers has three or more marking objects that are uniquely arranged specific to each of the plurality of tracking markers.

20. The method of claim 17, wherein the position of the tracking marker is determined through geometric triangulation calculation using three or more marking objects of the tracking marker.

21. A real-time tracking system comprising:
a drill piece comprising a sensor and a drill bit, wherein the sensor is adapted to detect electromagnetic signals from a tracking marker placed on a patient-specific surgical guide, and wherein the sensor is adapted to generate a relative position data of the tracking marker based on the electromagnetic signals; and
a computer comprising a display,
wherein the computer is adapted to visualize a virtual model of the patient-specific surgical guide, a virtual implant model placed at an implant site according to a virtual implant plan, and the patient's anatomy;
wherein the computer is further adapted to receive the relative position data of the tracking marker from the sensor of the drill piece, determine a relative position of the tracking marker with respect to the drill piece using the relative position data of the tracking marker, correlate the relative position of the tracking marker to a predetermined virtual position of the tracking marker in the virtual implant plan, and provide real-time visual feedback of the drill piece on the display of the computer.

22. The real-time tracking system of claim 21, wherein the computer is further adapted to determine the relative position of the tracking marker through geometric triangulation calculation using three or more marking objects of the tracking marker that are placed on a perimeter of the implant site.

23. The real-time tracking system of claim 22, wherein the computer is further adapted to identify the tracking marker from a plurality of tracking markers placed on the patient-specific surgical guide based on a unique spatial arrangement of the three or more marking objects.

24. The real-time tracking system of claim 21, wherein the patient-specific surgical guide is fabricated according to the virtual implant plan using scanned image data of the patient.
